(19) United States
(12) Patent Application Publication
(10) Pub. No.: US 2025/0014107 A1
(43) Pub. Date: Jan. 9, 2025

(54) QUBO Computing for Investment Optimization

(71) Applicant: Entanglement, Inc., New York, NY (US)

(72) Inventors: Gary KOCHENBERGER, BOULDER, CO (US); Fred GLOVER, BOULDER, CO (US); Haibo WANG, LAREDO, TX (US); Richard T. HENNIG, WESTMINSTER, CO (US)

(73) Assignee: Entanglement, Inc., New York, NY (US)

(21) Appl. No.: 18/399,487

(22) Filed: Dec. 28, 2023

Related U.S. Application Data
(60) Provisional application No. 63/477,818, filed on Dec. 29, 2022.

(51) Int. Cl. G06Q 40/06; G06Q 10/04

(52) U.S. Cl. CPC G06Q 40/06; G06Q 10/04

(57) ABSTRACT

An investment portfolio is determined by converting historical information about available investments and investment objectives into a probabilistic objective function, converting the probabilistic objective function into a quadratic unconstrained binary optimization (QUBO) problem, solving the QUBO problem with a quantum or quantum-inspired computer, and converting the optimized QUBO variables into real variables to determine an optimum distribution of funds.

### CROSS-REFERENCE TO RELATED APPLICATION

This application is a non-provisional patent application of U.S. Patent Application No. 63/477,818, filed Dec. 29, 2022, which is herein incorporated by reference.

### SUMMARY

According to an embodiment, a computer method for optimizing investments includes displaying, on an electronic computer display, a graphical user interface (GUI) to a user for receiving input about investment objectives and receiving the investment objectives, receiving data including historical returns on investment for a plurality of available investments, defining a probabilistic objective function for obtaining a desired investment objective with respect to a distribution of funds across the plurality of available investments and consistent with the data including historical returns on investment, and converting the probabilistic objective function to quadratic unconstrained binary optimization (QUBO) variables. The computer method may further include solving a QUBO problem defined by the QUBO variables with a quantum or quantum-inspired computer. The QUBO solution may be converted to real variables corresponding to an optimized distribution of funds across at least a portion of the plurality of available investments corresponding to the investment objectives.

Optionally, the optimized distribution of funds may be used to electronically drive stock market trades.

### BRIEF DESCRIPTION OF THE DRAWINGS

FIG. 1 is a flow chart illustrating a computer method for optimizing investments, according to an embodiment.

FIG. 2 is a diagram of a networked computer system configured to participate in execution of the computer methods described herein, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

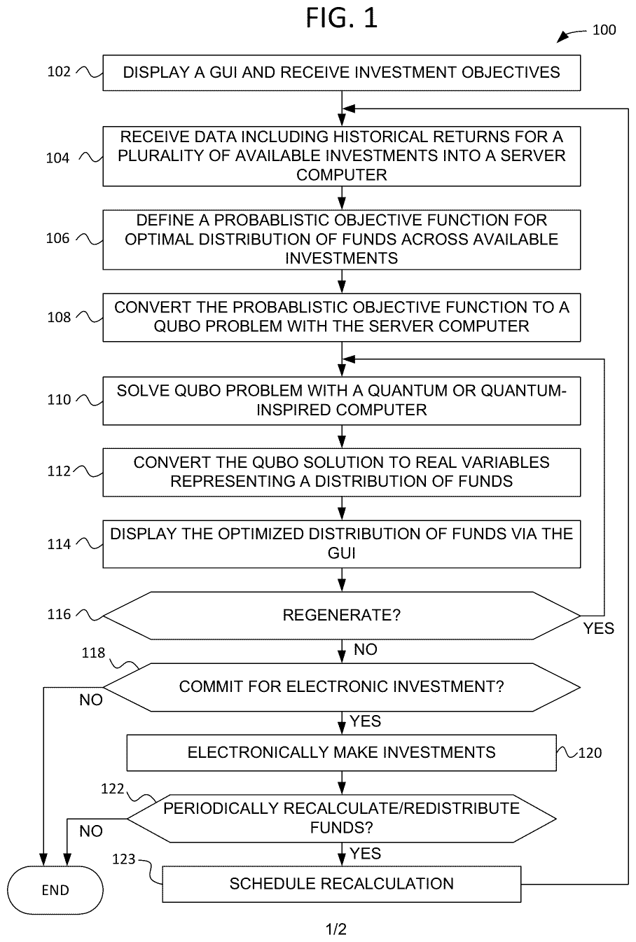

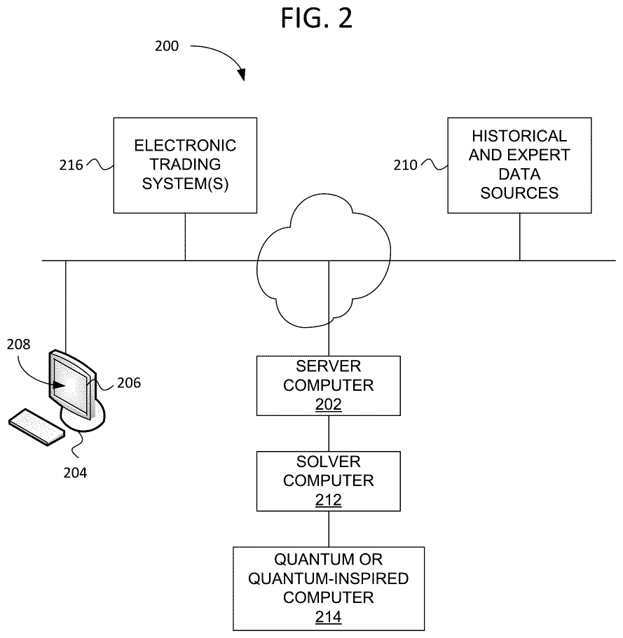

FIG. 1 is a flow chart illustrating a computer method 100 for optimizing investments, according to an embodiment. FIG. 2 is a diagram of a networked computer system 200 configured to execute the computer methods described in FIG. 1, according to an embodiment. Referring to the computer method 100 of FIG. 1 in view of the computer system 200 of FIG. 2, step 102 may include a server computer 202 displaying, on an electronic computer display 204 of a user computing device 206, a graphical user interface (GUI) 208 to a user for receiving input about investment objectives and receiving the investment objectives by actuation of controls displayed by the GUI. Step 104 includes receiving, into the server computer 202, data including historical returns on investment for a plurality of available investments from networked resources 210. Proceeding to step 106, a probabilistic objective function is defined by the server computer 202, the objective function being for obtaining a desired investment objective with respect to a distribution of funds across the plurality of available investments and consistent with the data including historical returns on investment.

Step 108 includes converting the probabilistic objective function to quadratic unconstrained binary optimization (QUBO) variables. This may be done by a QUBO solver program or computer 212 or the QUBO variables may be transmitted to the QUBO solver program or computer. Next, in step 110, a QUBO problem defined by the QUBO variables is solved with a quantum or quantum-inspired computer 214. As used herein, the term quantum-inspired computer, except where context is to the contrary, will be understood to refer to either a computer including a processor or co-processor with quantum-simulating gates, or a conventional computer running a program that simulates quantum computer behavior. For example, the server computer 202 may cause display of the GUI, for example via a browser, on a user computer 204, aggregate data received from the user and from networked historical and expert data sources 210, run the solver program 212, and/or run quantum-inspired software that solves the QUBO problem. Typically, the solver program runs the quantum or quantum-inspired computer, causing the QUBO problem to be run a plurality of times. Because quantum solutions are inherently uncertain, with respect to any one solution, running the QUBO problem multiple times ensures that a best solution is found. In step 112, the QUBO solution is converted to real variables corresponding to an optimized distribution of funds across at least a portion of the plurality of available investments corresponding to the investment objectives.

The method 100 may further include step 114, in which the optimized distribution of funds corresponding to the investment objectives are displayed via the GUI. Displaying the optimized distribution of funds corresponding to the investment objectives via the GUI may include displaying a “regenerate response” control configured to cause repetition of the solution. In one example, receiving a command via the “regenerate response” control may cause a repeat of the steps 110, solving the QUBO problem defined by the previously defined QUBO variables with the quantum or quantum-inspired computer; step 112, converting QUBO solution to real variables corresponding to another optimized distribution of funds; and step 114, displaying another optimized distribution of funds corresponding to the investment objectives via the GUI.

In another example, receiving the “regenerate response” command may cause the method 100 to loop through step 108, in which the probabilistic objective function is converted to another set of quadratic unconstrained binary optimization (QUBO) variables, followed by steps 110, 112, and 114. In another example, receiving the “regenerate response” command may cause the method 100 to loop through step 106, in which the (and possibly another) probabilistic objective function is defined, followed by steps 108, 110, 112, and 114.

Displaying the GUI in step 102 may optionally include displaying a natural language input control. Receiving the investment objectives in step 102 may include a receiving a time horizon and acceptable risk, a specification of currency available for investment, a selection of possible investments for inclusion in the available investments, and/or receiving a selection of possible investments for exclusion from the available investments. For example, this may include receiving a selection of a class of investments for exclusion or receiving a selection of a specific investment for exclusion.

The method 100 may further include, in step 118 receiving actuation of a “commit” control in the GUI, and, in step 120, electronically making investments corresponding to the optimized distribution of funds, for example, by sending commands to one or more networked trading systems 216. Electronically making the investments corresponding to the optimized distribution of funds may include making a market order for an equity, making a limit order for an equity, making an option order for an equity, short selling an equity, buying a mutual fund, buying an exchange traded fund, buying a bond, buying a cryptocurrency, and/or buying a non-fungible electronic token (NFT).

The method 100 may further include, in step 122, receiving a command via the GUI to periodically recalculate an optimum distribution of funds. This may be used, for example, to automate ongoing adjustments to the optimum distribution of funds responsive to ongoing events such as an equity rising to a selling price, falling to a stop limit price, changing economic conditions, changing expert opinion(s), and/or an external event that may affect the optimum distribution of funds.

Defining the probabilistic objective function, in step 106, may include defining tax liabilities corresponding to trades of existing investments. In this case, converting the QUBO solution to real variables corresponding to an optimized distribution of funds across at least a portion of the plurality of available investments, in step 112, includes converting the QUBO solution to real variables with an optimized distribution in view of the tax liabilities.

For embodiments that include step 120, electronically making investments corresponding to the optimized distribution of funds, step 120 may include electronically making adjustments to a previous distribution of funds to reduce exposure to previous investments inconsistent with the regenerated response.

Defining the probabilistic objective function, in step 106, may include defining respective probability distributions over returns of the available investments including means and standard distributions for a future period equal to or less than a time horizon received in the investment objectives, wherein the means and standard deviations are estimated from the historical returns data. The probability distributions may include a Gaussian distribution and/or a t-distribution.

Receiving data including historical returns on investment for a plurality of available investments, in step 104, may include receiving expert opinions. Accordingly, defining the probabilistic objective function, in step 106, may includes defining a Bayesian model including probability distributions for each of the available investments and at least one expert opinion spanning one or more of the available investments. The at least one expert opinion may be incorporated into the Bayesian model by modifying a probability distribution for an available investment spanned by the expert opinion. For example, the at least one expert opinion may be incorporated into the Bayesian model by representing probabilistic future returns for the available investments as random variables, using Bayesian inferences to modify historical returns on investment to include the expert opinions, and generating forecasts of the future investment results as functions of the Bayesian inferences.

Receiving data including historical returns on investment for a plurality of available investments, in step 104, may include receiving economic data and/or an economic data derivative. Defining the probabilistic objective function, in step 106, may include defining a Bayesian model including probability distributions for each of the available investments and the economic data and/or the economic data derivative spanning one or more of the available investments.

Receiving data including historical returns on investment for a plurality of available investments, in step 104, may include receiving historical stock market averages; and defining the probabilistic objective function, in step 106, may include defining a Bayesian model including probability distributions for each of the available investments and the historical stock market averages applicable to one or more of the available investments.

Receiving data including historical returns on investment for a plurality of available investments, in step 104, may include receiving constraints on the available investments. Defining the probabilistic objective function, in step 106, may incorporate the constraints.

Defining the probabilistic objective function, in step 106, may include representing probabilistic information as a set of probabilistic variables, and using the probabilistic variables to define the objective function.

Receiving data including historical returns on investment for a plurality of available investments, in step 104, may include receiving constraints on the available investments. Converting the probabilistic objective function to quadratic unconstrained binary optimization (QUBO) variables, in step 108, may include converting constraints into penalty functions.

Solving the QUBO problem defined by the QUBO variables with a quantum or quantum-inspired computer, in step 110, may consist of solving the QUBO problem with a quantum-inspired computer. Solving the QUBO problem with the quantum-inspired computer may include initializing all quantum bits (qubits) to one state, applying the initialized qubits by operating simulated quantum gates including a NOT gate and a CNOT gate, and reading states of the simulated quantum gates.

Solving the QUBO problem with the quantum-inspired computer may include running the QUBO problem by encoding the QUBO problem as a set of interacting quantum bits (qubits), initializing all qubits to one state, applying quantum gates to the qubits to cause the qubits to become entangled, and reading the final state of the qubits to determine a maximum or minimum to the QUBO problem.

Solving the QUBO problem with the quantum-inspired computer may include using the solver program to run a quantum Monte Carlo simulation to find a best solution. For example, solving the QUBO problem with the quantum-inspired computer may further includes using the solver program to solve the QUBO problem with the quantum-inspired computer a plurality of times, and comparing the QUBO solutions to determine a consensus of solutions or a best solution. Converting the QUBO solution to real variables corresponding to the optimized distribution of funds across at least a portion of the plurality of available investments corresponding to the investment objectives, in step 112, may include outputting the consensus of solutions or the best solution for converting the QUBO solution to the real variables.

Step 114 may include displaying, via the GUI, a list of selected investments with corresponding numbers of units to purchase.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer method for optimizing investments, comprising:
displaying, on an electronic computer display, a graphical user interface (GUI) to a user for receiving input about investment objectives and receiving the investment objectives;
receiving data including historical returns on investment for a plurality of available investments;
defining a probabilistic objective function for obtaining a desired investment objective with respect to a distribution of funds across the plurality of available investments and consistent with the data including historical returns on investment;
converting the probabilistic objective function to quadratic unconstrained binary optimization (QUBO) variables;
solving a QUBO problem defined by the QUBO variables with a quantum or quantum-inspired computer; and
converting the QUBO solution to real variables corresponding to an optimized distribution of funds across at least a portion of the plurality of available investments corresponding to the investment objectives.

2. The computer method for optimizing investments of claim 1, further comprising:
displaying, via the GUI, the optimized distribution of funds corresponding to the investment objectives.

3. The computer method for optimizing investments of claim 2, wherein displaying the optimized distribution of funds corresponding to the investment objectives via the GUI includes displaying a “regenerate response” control configured to cause repetition of solving the QUBO problem defined by the QUBO variables with the quantum or quantum-inspired computer, converting the QUBO solution to real variables corresponding to an optimized distribution of funds across at least a portion of the plurality of available investments, and displaying, via the GUI, the optimized distribution of funds corresponding to the investment objectives.

4. The computer method for optimizing investments of claim 3, wherein receiving a “regenerate response” actuation further causes a repetition of converting the probabilistic objective function to the quadratic unconstrained binary optimization (QUBO) variables.

5. The computer method for optimizing investments of claim 4, wherein receiving a “regenerate response” actuation further causes a repetition of defining the probabilistic objective function for obtaining the desired investment objective with respect to the distribution of funds across the plurality of available investments.

6. The computer method for optimizing investments of claim 2, wherein displaying the GUI includes displaying a natural language input control.

7. The computer method for optimizing investments of claim 2, further comprising:
receiving actuation of a “commit” control in the GUI; and
electronically making investments corresponding to the optimized distribution of funds.

8. The computer method for optimizing investments of claim 2, further comprising:
receiving a command via the GUI to periodically recalculate the optimum distribution of funds.

9. The computer method for optimizing investments of claim 1, wherein defining the probabilistic objective function includes defining tax liabilities corresponding to trades of existing investments.

10. The computer method for optimizing investments of claim 9, wherein converting the QUBO solution to real variables corresponding to an optimized distribution of funds across at least a portion of the plurality of available investments includes converting the QUBO solution to real variables with an optimized distribution in view of the tax liabilities.

11. The computer method for optimizing investments of claim 9, wherein electronically making investments corresponding to the optimized distribution of funds includes electronically making adjustments to a previous distribution of funds to reduce exposure to previous investments inconsistent with the recalculated response.

12. The computer method for optimizing investments of claim 1, wherein defining the probabilistic objective function includes defining respective probability distributions over returns of the available investments including means and standard distributions for a future period equal to or less than a time horizon received in the investment objectives, wherein the means and standard deviations are estimated from the historical returns data.

13. The computer method for optimizing investments of claim 12, wherein the probability distributions include at least one of a Gaussian distribution and a t-distribution.

14. The computer method for optimizing investments of claim 1, wherein receiving data including historical returns on investment for a plurality of available investments includes receiving expert opinions; and
wherein defining the probabilistic objective function includes defining a Bayesian model including probability distributions for each of the available investments and at least one expert opinion spanning one or more of the available investments.

15. The computer method for optimizing investments of claim 14, wherein the at least one expert opinion is incorporated into the Bayesian model by modifying a probability distribution for an available investment spanned by the expert opinion.

16. The computer method for optimizing investments of claim 14, wherein the at least one expert opinion is incorporated into the Bayesian model by:
representing probabilistic future returns for the available investments as random variables;
using Bayesian inferences to modify historical returns on investment to include the expert opinions; and
generating forecasts of the future investment results as functions of the Bayesian inferences.

17. The computer method for optimizing investments of claim 1, wherein receiving data including historical returns on investment for a plurality of available investments includes receiving at least one of economic data and an economic data derivative; and
wherein defining the probabilistic objective function includes defining a Bayesian model including probability distributions for each of the available investments and the at least one of the economic data and the economic data derivative spanning one or more of the available investments.

18. The computer method for optimizing investments of claim 1, wherein receiving data including historical returns on investment for a plurality of available investments includes receiving historical stock market averages; and
wherein defining the probabilistic objective function includes defining a Bayesian model including probability distributions for each of the available investments and the historical stock market averages applicable to one or more of the available investments.

19. The computer method for optimizing investments of claim 1, wherein receiving data including historical returns on investment for a plurality of available investments includes receiving constraints on the available investments; and
wherein defining the probabilistic objective function incorporates the constraints.

20. The computer method for optimizing investments of claim 1, wherein defining the probabilistic objective function includes representing probabilistic information as a set of probabilistic variables and using the probabilistic variables to define the objective function.

21. The computer method for optimizing investments of claim 1, wherein receiving data including historical returns on investment for a plurality of available investments includes receiving constraints on the available investments; and
wherein converting the probabilistic objective function to QUBO variables includes converting constraints into penalty functions.

22. The computer method for optimizing investments of claim 1, wherein solving the QUBO problem defined by the QUBO variables with the quantum or quantum-inspired computer consists of solving the QUBO problem with a quantum-inspired computer.

23. The computer method for optimizing investments of claim 22, wherein solving the QUBO problem with the quantum-inspired computer includes:
initializing all quantum bits (qubits) to one state;
applying the initialized qubits by operating simulated quantum gates including a NOT gate and a CNOT gate; and
reading states of the simulated quantum gates.

24. The computer method for optimizing investments of claim 22, wherein solving the QUBO problem with the quantum-inspired computer includes running the QUBO problem by:
encoding the QUBO problem as a set of interacting quantum bits (qubits);
initializing all qubits to one state;
applying quantum gates to the qubits to cause the qubits to become entangled; and
reading the final state of the qubits to determine a maximum or minimum to the QUBO problem.

25. The computer method for optimizing investments of claim 1, wherein solving the QUBO problem defined by the QUBO variables with the quantum or quantum-inspired computer further includes using a solver program to run a quantum Monte Carlo simulation to find a best solution.

26. The computer method for optimizing investments of claim 1, wherein solving the QUBO problem defined by the QUBO variables with the quantum or quantum-inspired computer further includes using the solver program to:
solve the QUBO problem with the quantum or quantum-inspired computer a plurality of times; and
compare the QUBO solutions to determine a consensus of solutions or a best solution;
wherein converting the QUBO solution to real variables corresponding to an optimized distribution of funds across at least a portion of the plurality of available investments corresponding to the investment objectives includes outputting the consensus of solutions or the best solution for converting the QUBO solution to the real variables.

27. The computer method for optimizing investments of claim 1, further comprising:
displaying, via the GUI, the optimized distribution of funds corresponding to the investment objectives including displaying a list of selected investments with corresponding numbers of units to purchase.
